(19) United States
(12) Patent Application Publication
(10) Pub. No.: US 2012/0080094 A1
(43) Pub. Date: Apr. 5, 2012

(54) METHOD AND DEVICE FOR FEEDING A PRESETTABLE MEASUREMENT QUANTITY OF A SAMPLE LIQUID

(75) Inventor: Michael MARTIN, Rossdorf (DE)

(73) Assignee: MERK PATENT GMBH, DARMSTADT (DE)

(21) Appl. No.: 13/248,381

(22) Filed: Sep. 29, 2011

(30) Foreign Application Priority Data
Oct. 2, 2010 (DE) 10 2010 047 405.3

(51) Int. Cl. G05D 11/00; F17D 3/00

(52) U.S. Cl. 137/9; 137/98

(57) ABSTRACT

A method and device for feeding a presettable measurement quantity of a sample liquid from a liquid reservoir via a feed line through a switching valve into a temporary store in order subsequently, after actuation of the switching valve, to feed the sample liquid to an analytical measuring instrument where the sample liquid is conveyed into the temporary store until further conveying of the sample liquid is terminated and the switching valve is actuated by evaluation of a characteristic quantity, wherein a flow rate of the sample liquid is determined at a time at which a first proportion of the sample liquid has already flowed through the switching valve, and the switching valve is actuated as a function of the flow rate determined and a switching delay determined in advance.

The invention relates to a method for feeding a presettable measurement quantity of a sample liquid from a liquid reservoir through a switching valve into a temporary store in order subsequently, after actuation of the switching valve, to feed the sample liquid to an analytical measuring instrument, where the sample liquid is conveyed into the temporary store until the switching valve is actuated and further conveying of the sample liquid is terminated by evaluation of a characteristic quantity.

In order to be able to carry out analytical measurements on a sample liquid, the sample liquid is usually fed to the analytical measuring instrument at a constant rate. The rate at which the measurement quantity of the sample liquid is fed to the analytical measuring instrument is usually preset by the analytical measuring instrument. If the sample liquid is consumed during performance of the measurement, as is the case, for example, in the case of an ICP mass spectrometer, the rate at which the sample liquid is fed to the measuring instrument will be crucially dependent on the consumption of the sample liquid during the measurement and will be matched thereto.

In many cases, a measurement can be carried out with low consumption of sample liquid. Indeed, the lowest possible consumption of the sample liquid during the measurement is often preset in order also to be able to carry out a measurement with small sample volumes of a few millilitres or less. Conveying devices which have a very low aspiration rate or conveying rate are known from practice. For example, atomiser devices are known which aspirate and atomise the sample liquid at a very low conveying rate in order to feed the atomised sample liquid to an ICP mass spectrometer. The atomisers known from practice have such a low aspiration rate for sample liquid that even very small sample volumes of 100 microlitres or less can be used for carrying out an analytical measurement.

Automatic sample feed devices have a removal device, by means of which a sample liquid can be removed from a liquid reservoir and fed to the analytical measuring instrument. The removal device is connected to the analytical measuring instrument via a feed line. If the conveying of the sample liquid removed using the removal device to the measuring instrument through the feed line is carried out using the same conveying device which also feeds the sample liquid to the measuring instrument at the lowest possible conveying rate, the removal and feed of the sample liquid takes a comparatively long time in the case of conventional measurement arrangements. For a measurement which can be carried out within several seconds or, for example, one minute, the sample liquid often has to be conveyed from the removal device to the analytical measuring instrument for several minutes in the case of the use of the same conveying device. Automated performance of a relatively large number of measurements is therefore associated with large consumption of time.

In order to reduce the time duration necessary for carrying out a measurement, it is known from practice firstly to convey a presettable measurement quantity of a sample liquid by means of a second conveying device through the removal device into a temporary store, which is arranged in the vicinity of the analytical measuring instrument. The sample liquid can subsequently be conveyed slowly out of the temporary store into the analytical measuring instrument. Since the measurement quantity of the sample liquid can be removed rapidly from the liquid reservoir and fed to the temporary store and only a comparatively short conveying distance has to be bridged from the temporary store to the analytical measuring instrument at a low conveying rate using the conveying device also used for the measuring instrument, the total time duration necessary for carrying out the measurement, including removal of the sample liquid, can be considerably reduced.

For process-technical reasons, the temporary store used is usually a line section of adequate length, into which the preset measurement quantity of the sample liquid can be conveyed and, after switching of the switching valve, can be conveyed out again.

However, it has been found that small measurement quantities of the sample liquid of a few 100 microlitres or less can no longer be conveyed fully with adequate accuracy into the temporary store and subsequently fed to the analytical measuring instrument without losses. Owing to the switching delays and reaction times, which are usually unavoidable in the case of the components used for measurement and control, it is virtually impossible to ensure, in particular in the case of measurement quantities of about 100 microlitres or less, that the proposed measurement quantity has been conveyed fully into the temporary store and at the same time is still in contact with the switching valve, so that the sample liquid can be conveyed into the measuring instrument without interruptions on switching of the switching valve.

It is therefore regarded as being an object of the present invention to design a method for feeding a preset measurement quantity of a sample liquid of the generic type mentioned at the outset in such a way that the sample liquid can be conveyed into the temporary store at a high rate and it can simultaneously be ensured that the preset measurement quantity can firstly be conveyed into the temporary store and subsequently into the analytical measuring instrument with as few losses as possible.

This object is achieved in accordance with the invention in that a flow rate of the sample liquid is determined at a time at which a first proportion of the sample liquid has already flowed through the switching valve, and in that the switching valve is actuated as a function of the flow rate determined and a switching delay determined in advance. Investigations have shown that, owing to, for example, the viscosity or other flow-relevant properties, the flow rate of different sample liquids through the feed line, through the switching valve and through the temporary store can vary considerably.

In the case of rapid filling of the temporary store, it is not possible, owing to the switching delays which usually occur, to fill the temporary store completely with the sample liquid removed and to terminate further rapid conveying of the sample liquid at a fill level in the temporary store which is matched to the preset measurement quantity. Depending on the flow rate and switching delay, switching would take place either too early or too late, and the temporary store would be filled with too little or too much sample liquid. It is likewise not sufficient to determine the flow rate, for example, in the removal device, since the flow rate of the sample liquid changes, in particular, on flowing through the switching valve.

However, it has been found that determination of the flow rate can lead to accurate results if the measurement quantity of the sample liquid has already flowed through the switching valve. Starting from a flow rate determined in this way and in knowledge of a switching delay, in particular of the switching valve, determined in advance, it is possible to calculate the time at which the switching valve has to be actuated in order to pass the preset measurement quantity of the sample liquid into the temporary store up to the switching of the switching valve after the switching delay.

It is preferably provided that the flow rate is determined at an end of the removal quantity of the sample liquid in the feed line. The feed line which connects the liquid reservoir to the switching valve is usually sufficiently long to enable measurement of the flow rate at a particularly suitable position. This position can be pre-specified in a simple manner so that a first proportion of the sample liquid has flowed through the switching valve and determination of the flow rate is complete before the switching valve has to be actuated, taking into account the switching delay.

For this purpose, it is provided that the flow rate is determined by means of a measurement device which is arranged along the feed line at a distance in front of the switching valve. This distance is expediently somewhat greater than the distance covered by the sample liquid in the feed line within the time duration of the switching delay at usual conveying rates. After determination of the flow rate, sufficient time remains, in the case of such a design of the measurement method, to calculate the time of activation of the switching valve and to actuate the switching valve in such a way that the preset measurement quantity of the sample liquid can be conveyed into the temporary store with high precision.

The method described above requires that the flow rate of the sample liquid is determined at the end of the removal quantity of the sample liquid. The removal quantity should therefore be if possible somewhat larger, but not much larger, than the measurement quantity of the sample liquid intended for the measurement.

In the case of automated performance of the method, it is possible to use, for example, microtitre plates in which a large number of liquid reservoirs, each containing a small quantity of sample liquid, can be provided and used successively for the measurement. Each individual liquid reservoir can store a quantity of sample which is somewhat larger than the measurement quantity of the sample liquid intended for the measurement. While each individual measurement is carried out, the liquid reservoir can be emptied completely, where the removal quantity is then somewhat larger than the measurement quantity of the sample liquid, and where the measurement method described above can be carried out in an automated manner.

However, applications in which a larger quantity of sample liquid is available in a liquid reservoir are also conceivable. For the measurement, however, the aim is to use only the smallest possible measurement quantity. In order nevertheless to be able to use the measurement method according to the invention and to be able to carry out a measurement of the flow rate at an end of the removal quantity of the sample liquid, it is provided that a presettable removal quantity of the sample liquid which is somewhat larger than the measurement quantity of the sample liquid is removed from the liquid reservoir. In this way, a liquid thread of the sample liquid, which has a beginning and an end, can be generated in the feed line. The liquid thread has an interface to another fluid, usually air or a neutral solution, both at the front and also at the back.

It is preferably provided that a sensor device is arranged along the feed line between the liquid reservoir and the switching valve and determines the quantity of sample liquid removed from the liquid reservoir at a presettable distance from the liquid reservoir.

For this purpose, it may be provided that the sensor device for determination of the removed quantity of sample liquid is arranged at a distance from the liquid reservoir which is such that a volume of the interior of the feed line between the liquid reservoir and the sensor device corresponds approximately to the removal quantity. It is then merely necessary to establish, using the sensor device, the time at which the beginning of the removed sample thread of the sample liquid in the feed line is conveyed past the sensor device. The volume of sample liquid already removed from the liquid reservoir at this time and located in the feed line then corresponds directly to the preset removal quantity, so long as any switching delays arising have no significant influence or are taken into account appropriately.

It may also be advantageous or necessary, for example owing to an inadequate length of the feed line, to arrange the sensor device at a suitable point inside the temporary store. If the temporary store used is a line loop of adequate length, the sensor device can be arranged along the line loop at a suitable distance from the switching valve or the liquid reservoir.

When presetting the removal quantity, the highest possible precision is not important, meaning that the influence of a flow rate which is different depending on the sample liquid used can be neglected and it is not necessary to determine a flow rate for the determination and presetting of the removal quantity.

Inexpensive and reliable determination of the flow rate and, if necessary, the quantity of sample liquid removed from the liquid reservoir can be accomplished by the sensor devices, or the measurement device, being able to detect, in a non-contact manner, passage of an interface between the sample liquid and another fluid. The sensor devices can, for example, have light boxes which are able to establish a change in the optical properties of the feed line, which is designed to be transparent at least in this region. Depending on whether sample liquid or alternatively another fluid, for example air or a neutral solution having pre-known optical properties, is located in the feed line, the optical properties which can be measured by means of the sensor device, such as, for example, the transmission or reflection of a light beam passing through the feed line, change. The passage of an interface between the sample liquid and another fluid can be established reliably in this way. The often considerably greater complexity for continuous measurement of a flow rate of a quasi-continuously conveyed sample liquid is not necessary.

Since the sensor devices measure in a non-contact manner, an undesired influence of the sensor devices, or the measurement device, on the flow rate and the conveying of the sample liquid can be avoided. In addition, a separate measurement space, which would virtually unavoidably contribute to further loss quantities of sample liquid which remain in the measurement space and cannot be used for the measurement using the analytical measuring instrument, is not necessary for a non-contact measurement.

The invention also relates to a device for carrying out the method described above. It is provided in accordance with the invention that a measurement device for determination of a flow rate is arranged along the feed line at a distance in front of the switching valve. The measurement device has, preferably arranged at a distance from one another, a first sensor device and a second sensor device, which are able to detect the passage of an interface between the sample liquid and another fluid. The flow rate can be calculated as a function of the separation of the two sensor devices and the time difference of the passage of the interface by the sample liquid. The design complexity necessary for determination of the flow rate can be kept low in this way.

The arrangement of the measurement device at a distance in front of the switching valve enables it to be ensured, in a simple manner, that a first proportion of the sample liquid has already flowed through the switching valve when the flow rate is determined at the end of the removal quantity of the sample liquid. Furthermore, it can be ensured that, owing to the distance of the measurement device from the switching valve, adequate time is still available for the switching valve to be actuated, taking into account the unavoidable switching delay, in such a way that the preset measurement quantity of the sample liquid is conveyed into the temporary store with the highest possible accuracy before the switching valve switches.

According to an advantageous embodiment of the inventive idea, it is provided that the device has a controllable removal device for the removal of a presettable removal quantity of the sample liquid from the liquid reservoir. The removal device can have, for example, a displaceable or actuatable suction needle, which can be lowered successively or alternatively into individual cavities of a microtitre plate and withdrawn again. In order to begin the conveying of the removal quantity of the sample liquid from the liquid reservoir, the suction needle is lowered into the desired cavity and activated. If only a small quantity of sample liquid is present in the cavity, which corresponds approximately to the preset removal quantity, the sample liquid located in the cavity can be removed completely. If, however, the quantity of sample liquid present in the cavity is larger than the preset removal quantity, the suction needle can be switched off and/or withdrawn from the liquid reservoir when the removal quantity of the sample liquid has been reached, in order to prevent further removal of the sample liquid from the liquid reservoir. The removal quantity of sample liquid that has already been removed is conveyed through the feed line into the temporary store.

In a reliable manner which is simple in design, a quantity of sample liquid which has already been removed can be determined by the device having a third sensor device which is arranged along the feed line between the liquid reservoir and the switching valve. The distance between this third sensor device and the liquid reservoir is advantageously preset here in such a way that the volume of the interior of the feed line between the liquid reservoir and the third sensor device corresponds approximately to the removal quantity. In this case, further removal of sample liquid from the liquid reservoir can be terminated as soon as a beginning of a liquid thread of the sample liquid is conveyed past the third sensor device in the feed line.

It is provided in accordance with the invention that the first sensor device and the second sensor device and, if used, the third sensor device enable non-contact determination of the passage of an interface between the sample liquid and another fluid. The sensor devices can have, for example, a light box which is able to establish a change in the optical properties in the case of a change between the sample liquid and another fluid. The sensor devices can also be based on another measurement method and establish, for example by means of ultrasound or via capacitive properties, the passage of an interface between the sample liquid and another fluid. If one measurement device is able to determine the flow rate of the sample liquid continuously in a non-contact manner using one sensor device, the use of a second sensor device is not necessary.

Illustrative embodiments of a method according to the invention and of a device which is suitable for carrying out the former are explained in greater detail below and are depicted in the drawings, in which:

### BRIEF DESCRIPTION OF DRAWINGS

FIG. 1 shows a diagrammatic representation of a device for feeding a presettable measurement quantity of a sample liquid to an analytical measuring instrument, where the sample liquid conveyed out of a liquid reservoir is conveyed through a switching valve into a temporary store,

FIG. 2 shows a view of the device depicted in FIG. 1 after switching of the switching valve, so that the sample liquid stored in the temporary store is fed to an analytical measuring instrument,

FIG. 3 shows an enlarged and diagrammatic view of a measurement device for determination of a flow rate, which is arranged along a feed line between the liquid reservoir and the switching valve, and

FIG. 4 shows a view as in FIG. 3, where a device of modified design additionally has a controllable removal device and a third sensor device.

A device 1 depicted in the figures for feeding a presettable measurement quantity of a sample liquid to an analytical measuring instrument 2 has a removal device 3, which is able to remove sample liquid from a liquid reservoir 4. The removal device 3 is connected to a switching valve 6 via a feed line 5.

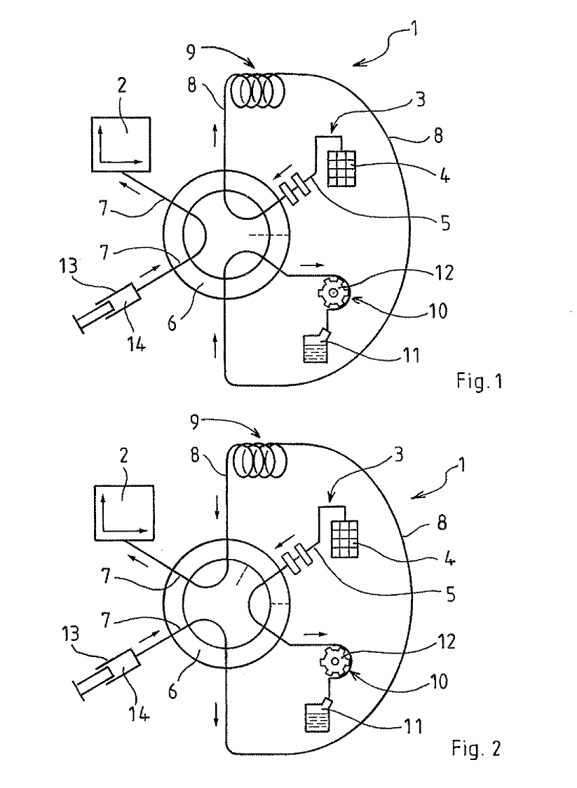

The switching valve 6 is designed as a triple switching valve and has six connections 7, of which two adjacent connections 7 can be connected to one another to allow conveying. In the state depicted in FIG. 1, the feed line 5 is connected to a line loop 8, which is used as temporary store 9, to allow conveying. The line loop 8 is connected to a second conveying device 10 via the switching valve 6 and runs into a disposal tank 11. The second conveying device 10 has a peristaltic pump 12. The peristaltic pump 12 conveys, at a high conveying rate, a sample liquid removed from the liquid reservoir 4 by means of the removal device 3 through the feed line 5 and through the switching valve 6 into the line loop 8 used as temporary store 9.

At the same time, a first conveying device 13 conveys a neutral solvent 14 to the analytical measuring instrument 2 via a further connecting passageway of the switching valve 6. The conveying rate of the first conveying device 13 is considerably lower than the conveying rate of the second conveying device 10, meaning that only a very small quantity of the neutral solvent 14 is conveyed into the analytical measuring instrument 2 and consumed therein.

The arrows depicted in the region of the connections 7 of the switching valve 6 in each case indicate the flow direction of the sample liquid or of the neutral solvent.

FIG. 2 depicts a state after switching of the switching valve 6. The switching valve 6 has been actuated after a measurement quantity of sample liquid intended for the measurement has been conveyed into the line loop 8 used as temporary store 9. The peristaltic pump 12 aspirates air or likewise a neutral solvent from the removal device 3 at a high conveying rate, since further removal of sample liquid has been stopped by the removal device 3. The first conveying device 13 is now connected to the line loop 8 and slowly forces the sample liquid stored therein back through the switching valve 6 and on to the analytical measuring instrument 2. The measurement can begin as soon as the sample liquid has covered the distance from the switching valve 6 to the analytical measuring instrument 2.

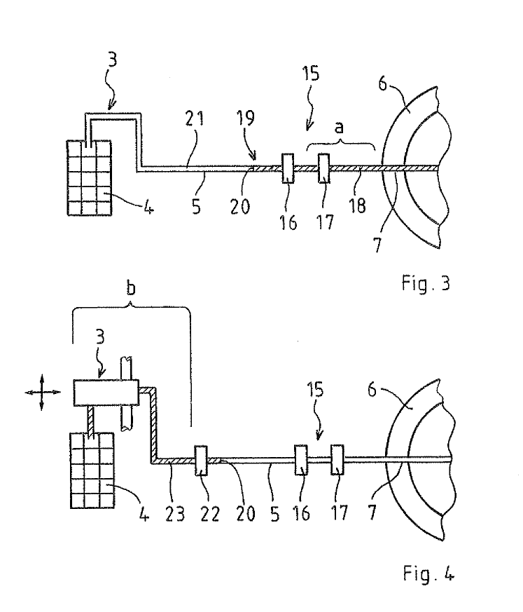

FIG. 3 depicts in a diagrammatic and enlarged manner a part-region of the device 1 with the removal device 3, the switching valve 6 and the connecting feed line 5. A measurement device 15 is arranged on the feed line 5 at a distance a in front of the switching valve 6. The measurement device 15 has a first sensor device 16 and a second sensor device 17 at a distance from the first sensor device 16.

A liquid thread 18 of the sample liquid sucked out of the liquid reservoir 4 via the removal device 3 is located in the feed line 5. The liquid thread 18 has an interface 20 to a following fluid 21 at an end 19 which has not yet been conveyed into the switching valve 6. The following fluid 21 can be air or likewise a neutral solvent, which is sucked out of the liquid reservoir 4 instead of the sample liquid and is conveyed through the feed line 5 after the sample liquid.

Both sensor devices 16, 17 are able to detect, via a light box, the passage of the interface 20 at the end 19 of the liquid thread 18 of the sample liquid. The flow rate of the sample liquid can be determined via the separation of the two light boxes, or sensor devices 16 and 17, and the time difference between the respectively detected passages of the interface 20 of the liquid thread 18. Since a front part of the liquid thread 18 has already flowed through the switching valve 6 and into the line loop 8 used as temporary store 9, the flow rate no longer changes significantly after the measurement by means of the measurement device 15, meaning that the switching of the switching valve 6 can be effected, in knowledge of a switching delay determined in advance, at a time at which the intended measurement quantity of sample liquid has already been conveyed into the temporary store 9 and the end 19 of the liquid thread 18 has not yet been conveyed through the switching valve 6. After switching of the switching valve 6, the sample liquid immediately flows out of the switching valve 6 again back in the direction of the analytical measuring instrument 2.

FIG. 4 depicts by way of example a third sensor device 22, which is arranged along the feed line 5 between the liquid reservoir 4 or the removal device 3 and the switching valve 6. A distance b, measured along the feed line 5, between the third sensor device 22 and the liquid reservoir 4 is selected so that a liquid thread 23, which is located in the feed line 5 and extends as far as the third sensor device 22, has approximately the volume of sample liquid which is intended for the removal quantity. As soon as the third sensor device 23 detects the passage of a front interface 20 of the liquid thread 18 of the sample liquid sucked out of the liquid reservoir 4, further removal of sample liquid from the liquid reservoir 4 is terminated by the controllable removal device 3. The length of the liquid thread 18 is then such that the temporary store 9 can be sufficiently filled, and the flow rate of the sample liquid can be measured at the end 19 of the liquid thread 18, and the optimum time for switching of the switching valve 6 can be determined.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

The entire disclosure[s] of all applications, patents and publications, cited herein and of corresponding German application No. DE 102010047405.3, filed Oct. 2, 2010, are incorporated by reference herein.

From the foregoing description, one skilled in the art can easily ascertain the essential characteristics of this invention and, without departing from the spirit and scope thereof, can make various changes and modifications of the invention to adapt it to various usages and conditions.

1. A method for feeding a presettable measurement quantity of a sample liquid from a liquid reservoir via a feed line through a switching valve into a temporary store in order subsequently, after actuation of the switching valve, to feed the sample liquid to an analytical measuring instrument where the sample liquid is conveyed into the temporary store until the switching valve is actuated and further conveying of the sample liquid is terminated by evaluation of a characteristic quantity, wherein a flow rate of the sample liquid is determined at a time at which a first proportion of the sample liquid has already flowed through the switching valve (6), and in that the switching valve (6) is actuated as a function of the flow rate determined and a switching delay determined in advance.

2. A method according to claim 1, wherein the flow rate is determined at an end (19) of a removal quantity of the sample liquid in the feed line (5).

3. A method according to claim 1, wherein the flow rate is determined by a measurement device (15) which is arranged along the feed line (5) at a distance in front of the switching valve (6).

4. A method according to claim 1, wherein a presettable removal quantity of the sample liquid which is somewhat larger than the measurement quantity of the sample liquid is removed from the liquid reservoir (4).

5. A method according to claim 4, wherein a sensor device (22) is arranged along the feed line (5) between the liquid reservoir (4) and the switching valve (6) and determines the quantity of sample liquid removed from the liquid reservoir (4) at a distance from the liquid reservoir (4).

6. A method according to claim 5, wherein the sensor device (22) for determination of the removed quantity of sample liquid is arranged at a distance from the liquid reservoir (4) which is such that a volume of the interior of the feed line (5) between the liquid reservoir (4) and the sensor device (22) corresponds approximately to the removal quantity.

7. A method according to claim 3, wherein sensor devices (16, 17, 22), or the measurement device (15), are able to detect, in a non-contact manner, the passage of an interface (20) between the sample liquid and another fluid.

8. A device for feeding a presettable measurement quantity of a sample fluid from a liquid reservoir through a feed line and through a switching valve into a temporary store in order subsequently, after actuation of the switching valve, to be able to feed the sample liquid to an analytical measuring instrument by a first conveying device, where the sample liquid is conveyed into the temporary store by a second conveying device until further conveying of the sample liquid is terminated and the switching valve is actuated by evaluation of a characteristic quantity, wherein a measurement device (15) for determination of a flow rate is arranged along the feed line (5) at a distance in front of the switching valve (6).

9. A device according to claim 8, wherein the measurement device (15) has, arranged at a distance from one another, a first sensor device (16) and a second sensor device (17), which are able to detect the passage of an interface (20) between the sample liquid and another fluid.

10. A device according to claim 8, wherein the device (1) has a controllable removal device (3) for the removal of a presettable removal quantity of the sample liquid from the liquid reservoir (4).

11. A device according to claim 10, wherein the device (1) has a third sensor device (22), which is arranged along the feed line (5) between the liquid reservoir (4) and the switching valve (6).

12. A device according to claim 8, wherein the first sensor device (16) and the second sensor device (17) and, if present, the third sensor device (22) are capable of non-contact determination of the passage of an interface (20) between the sample liquid and another fluid.
